(19) United States
(12) Patent Application Publication
(10) Pub. No.: US 2026/0008298 A1
(43) Pub. Date: Jan. 8, 2026

(54) A WHEEL FOR A PUSHCHAIR AND A PUSHCHAIR HAVING A WHEEL

(71) Applicant: JIJIBABA LIMITED, London (GB)

(72) Inventors: Björn DAHLSTRÖM, London (GB); Richard SCHLAGMAN, London (GB)

(21) Appl. No.: 18/997,247

(22) PCT Filed: Jul. 19, 2023
(86) PCT No.: PCT/EP2023/070083

§ 371 Date: Jan. 21, 2025

(30) Foreign Application Priority Data
Jul. 19, 2022 (GB) 2210584.5

(51) Int. Cl. B60B 9/26; B60C 7/14; B62B 7/00; B62B 7/06; B62B 9/18

(52) U.S. Cl. CPC B60B 9/26; B60C 7/146; B62B 9/18; B62B 7/002; B62B 7/062; B62B 2301/25

(57) ABSTRACT

The invention provides a wheel for a pushchair, the wheel comprising a an inner hub for connection to an axle, an outer rim for engaging the ground in use a plurality of spokes connected between the inner hub and the outer rim, wherein the spokes are flexible.

The present invention relates to a wheel for a pushchair and a pushchair having the wheel. The invention also relates to a method of providing suspension to a pushchair. The invention also relates to wheels for other small vehicles or rollable devices or items such as a suitcase that has attached wheels.

Pushchairs are very well known devices for conveying an infant or a small child.

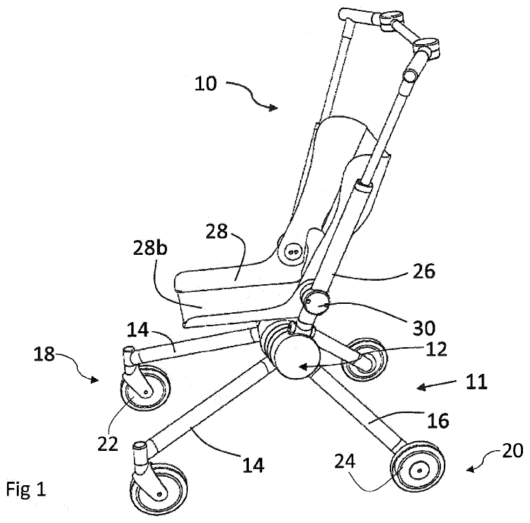

Typically a pushchair has a chair assembly arranged on a chassis having one or more wheels to facilitate movement of the pushchair. FIG. 1 is a schematic view of a pushchair described in co-pending international application number WO2022/101517, of the same applicant.

FIG. 1 show a pushchair 10 in an unfolded state. The pushchair 10 generally comprises a subframe in the form of a chassis assembly 11, a handle assembly 26 connected thereto, and a seat assembly 28. In this example, the seat assembly 28 is mounted on the handle assembly 26 by seat mounting means 30. As can be seen, in normal use, in an unfolded state normally the seat back will be in a substantially upright position. The seat back can preferably be reclined partially or fully. The seat base 28b will typically remain in a generally horizontal position when the pushchair 10 is in the shown unfolded state.

A pair of forward extending wheel-supporting legs 14 and a pair of rearward extending wheel-supporting legs 16 are rotatably mounted on a central body portion 12 of the chassis assembly 11. At distal ends of the forward extending legs 14 are front wheels 18 and at distal ends of rearward extending legs 16 are rear wheels.

Normally, the rear wheel assemblies 20 are arranged so that rear wheels 24 can rotate about a substantially horizontal axis. Front wheel assemblies 18 include front wheels 22 that can rotate about the normally horizontal axis and are additionally arranged so that they can rotate about a substantially vertical axis, so providing a potential steering facility in order to increase the manoeuvrability of the pushchair 10.

In known pushchairs, the wheel assemblies may take many different forms. Further it is noted that the description herein is in relation to wheels for pushchairs but the wheels are equally usable with other small vehicles such as a golf cart, a wheelchair, a golf trolley, a shopping trolley, a bicycle and a tricycle, and any other small vehicle. For example, the wheels could also be provided as the wheels on a suitcase or rollable bag.

Devises such as pushchairs are generally simple in construction and so the incorporation of overly complex mechanisms is neither not appropriate nor desirable. It is however desired that the pushchair is capable of providing a smooth journey experience to the baby or small child carried within it. Similarly in the example of other small vehicles such as a golf cart, a wheelchair, a golf trolley and a shopping trolley it is desirable that the vehicle can move smoothly in normal use and can negotiate without difficulty unevenness on a surface upon which it is pushed.

Suspension systems have been tried and used in such buggies but they are generally complex in construction and therefore costly. One example can be seen in CN114030524, which provides for a spring based suspension system connected to frame elements of the pushchair.

US2020/114687, US2020207150, US2017341,464, WO2013/138548, US2006/113016 disclose examples of wheels including flexible spokes connected between an inner hub and an outer rim of a wheel for a large vehicle.

A simplified suspension mechanism is desired for a pushchair or other such small vehicle.

According to a first aspect of the present invention, there is provided a wheel for a small vehicle such as a pushchair, the wheel comprising an inner hub for connection to an axle; an outer rim for engaging the ground in use; a plurality of spokes connected between the hub and the outer rim, wherein the spokes are flexible.

A wheel is provided that can be provided on a pushchair or other small vehicle and provides a simple and robust means for ensuring that the vehicle has suspension and can provide a smooth ride to a passenger or comfortable experience to a user pushing the vehicle. The wheel is suitable for a vehicle driven by manual operation, i.e. by an operator pushing or pulling the vehicle to cause the vehicle to move.

In one embodiment, the spokes have a thickness or cross-sectional area that decreases from a radially inner position to a radial outer position, or vice versa, i.e. the spokes have a thickness or cross-sectional area that decreases from a radially inner position to a radial outer position. In other words, the spokes become more flexible as the distance from the radial centre increases. This biases the spokes to bend or give to a great degree the further the position from the centre of the wheel (i.e. the further the position from the junction of the spoke to the wheel hub). As will be explained below, in use this produces the effect of a two-stage compression which is beneficial. Depending on the variation is thickness, shape, material etc of the spokes, multi-stage compression could be provided but in practice a two-stage compression is preferable.

In one embodiment, the spokes have a thickness or cross-sectional area that decreases continually from a radially inner position at its connection to the inner hub to a radial outer position at its connection with the outer rim. In an alternative configuration, the spokes have a thickness or cross-sectional area that increases continually from a radially inner position at its connection to the inner hub to a radial outer position at its connection with the outer rim. In a preferred example the thickness of the spoke is the magnitude of the transverse cross-sectional area of the spoke.

In one embodiment, the spokes have a variation in thickness or cross-sectional area such that in use they provide a two stage suspension effect.

In one embodiment, the variation in thickness or cross-sectional area is provided such that upon application of a first force one or more of the spokes deforms defining a knee. Preferably the spokes are arranged such that the knees of adjacent spokes can come into contact, although the spokes may also be spaced such that the knees are formed in use but the spacing between spokes is such that adjacent spokes do not come into contact.

The first stage of suspension effect is thus provided upon application of force at a first level, which might typically occur in common everyday use. For example, if used on a pushchair, the knee or kink in a spoke may occur when going over a stone or down a kerb. This would be a typical occurrence when pushing the pushchair and would ensure that a relatively high level of comfort is experienced by a passenger in the pushchair.

In one embodiment, the variation in thickness is provided such that once the defined knee has come into contact with an adjacent spoke, the remainder of the spoke will come into contact only if the force exceeds a defined threshold. The knee is generally formed at a point where the thickness of the spoke has changed due to the variation along the length so as to encourage or bias deformation at that point. In other examples, instead of variation in thickness other variations in the spoke can be used to determine the position of knee formation. In an example, the spoke which changes shape (e.g. cross sectional shape) rather than thickness i.e. it goes from a flat rectangle to a cylindrical shape in the middle or has a twist so that a “weaker” section is in the middle of the spoke to encourage formation of the knee in use.

Thus, a second stage or level of suspension is provided. Once the knee has already come into contact further contact between spokes will occur only if a higher force is experienced by the user. This could arise in normal but less common use of a pushchair, for example, if a user inadvertently pushes the pushchair into a high kerb or drops down a larger than expected step for example,. The specific details of force required to cause the initial knee contact and then the subsequent spoke contact can be selected and controlled by variation of material or thickness (or shape) variation of the spokes in the wheel.

In one embodiment, each spoke connects to the inner hub at one circumferential position and to the outer rim at a different circumferential position such that the spoke is sloped between the inner hub and the outer rim defining an acute angle between a tangent to the hub or the rim.

In one embodiment, the connection between at least one and preferably all of the spokes and the outer rim is radiused.

In one embodiment, the connection between at least one and preferably all of the spokes and the inner hub radiused.

In one embodiment, the wheel is a moulded wheel.

In one embodiment, the wheel is a unitary moulded wheel.

In one embodiment, the wheel is formed of a uniform composition throughout.

In one embodiment, the wheel is formed of a composition that varies along the length of the spokes.

In one embodiment, the diameter of the wheel is between 10 and 50 cm and preferably between 18 and 28 cm. These dimensions are given as a preferred range but are not limiting. They represent typical wheel diameters for pushchairs or small vehicles such as a golf cart, a wheelchair, a golf trolley and a shopping trolley.

In an embodiment the axial width of the molded wheel varies in dependence on radius. Preferably the wheel is thicker at its radially inner position than at its radially outer position, In other words, in the axial direction the wheel is thicker closer to the centre. This provides an efficient and effective way by which the amount of material in some or all of the spokes can be varied with radius.

According to a second aspect of the present invention, there is provided a pushchair having a chassis, a seat and at least three legs, each leg having a wheel provided thereon to facilitate movement of the pushchair, wherein at least one of the wheels is a wheel according to the first aspect of the present invention.

According to a third aspect of the present invention, there is a provided a method of providing suspension to a pushchair, the method comprising providing to a pushchair having a chassis, a seat and one or more wheel supporting legs, a plurality of wheels, at least one of which wheels comprises an inner hub for connection to an axle; an outer rim for engaging the ground in use; a plurality of spokes connected between the hub and the outer rim, wherein the spokes are flexible.

According to a further aspect of the present invention, there is provided a small vehicle having one or more wheels to facilitate movement, wherein at least one of the wheels is a wheel according to the first aspect of the present invention. In one example the vehicle is selected from the group comprising a pushchair, a golf cart, a wheelchair, a golf trolley and a shopping trolley.

Embodiments of the present invention will now be described in detail with reference to the accompanying drawings, in which:

FIG. 1 is a schematic view of a pushchair;

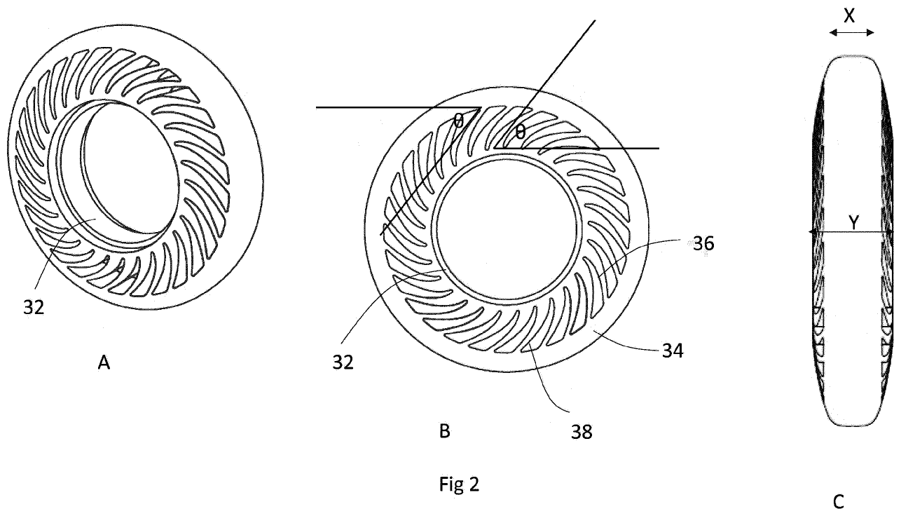

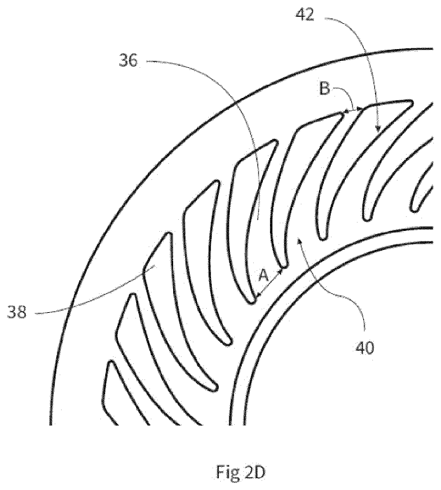

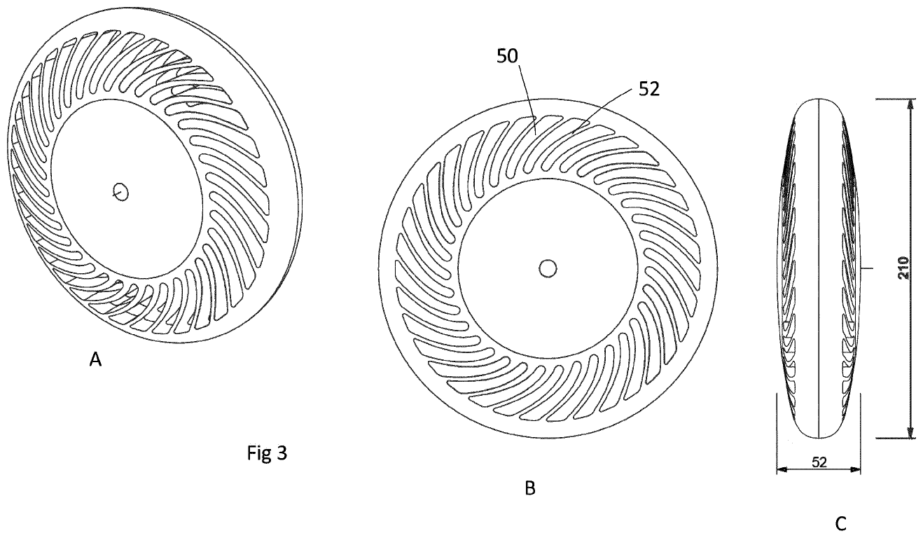

FIGS. 2A to 2D are schematic views of a first example of a wheel for a pushchair;

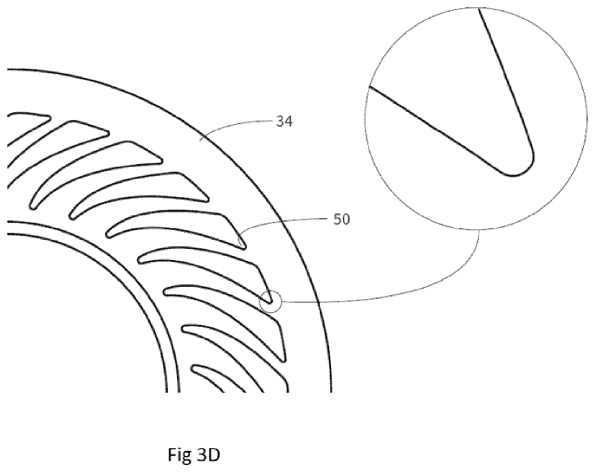

FIGS. 3A to 3D are schematic views of a second example of a wheel for a pushchair;

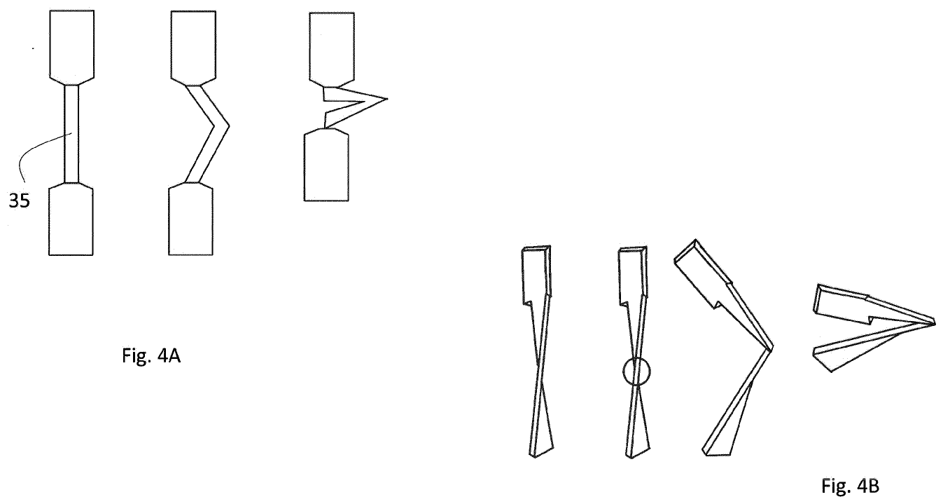

FIGS. 4A and B show exemplary embodiments of spokes for use in the wheel of any of FIGS. 1 to 3;

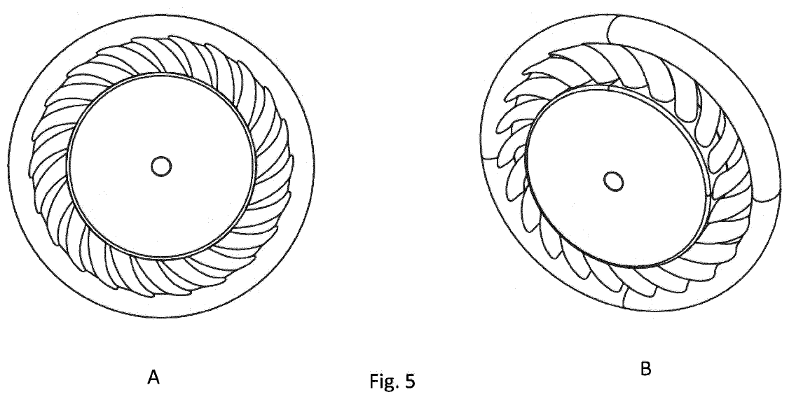

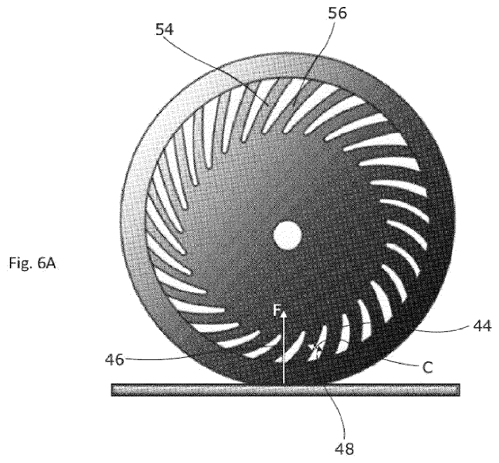

FIGS. 5A and 5B are schematic views of a further example of a wheel for a pushchair;

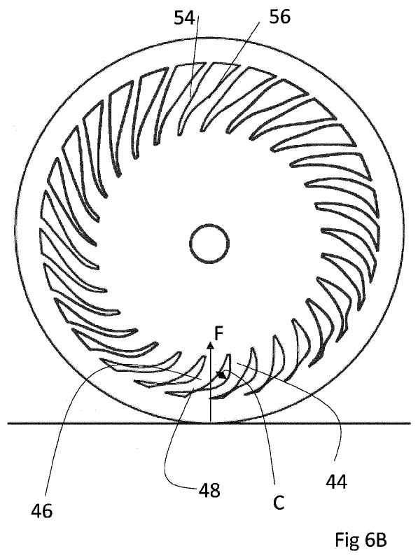

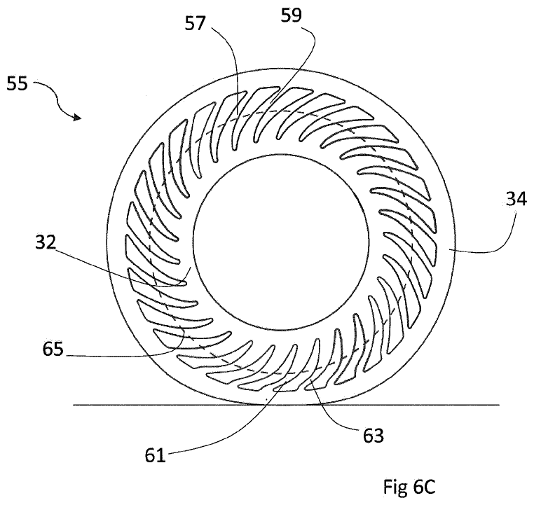

FIGS. 6A to 6C are views of a wheel showing stresses on a wheel for a pushchair in use; and

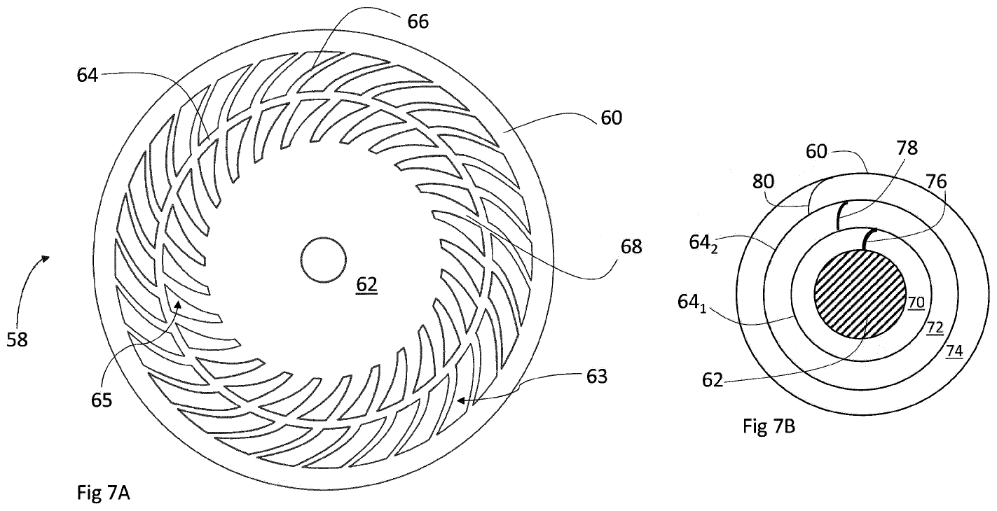

FIGS. 7A and 7B are schematic views of a further example of a wheel for a pushchair;

A wheel for a small vehicle such as a pushchair or a golf cart is provided. The wheel includes an inner hub for connection to an axle, e.g. directly or via a bearing or bearing assembly, and an outer rim for engaging the ground in use. A plurality of spokes are provided connected between the hub and the rim. The spokes are flexible and serve to provide suspension and control of the position of the pushchair or golf cart with respect to the ground in use. The wheel provides a simple and effective way for providing suspension to a small vehicle such as a pushchair. Thus, the comfort of a passenger in a pushchair, such as a baby or a toddler, can be increased without the need for complex controls on the frame or otherwise provided on the pushchair itself.

Referring again to FIG. 1 showing a schematic view of a pushchair, it can be seen that the pushchair comprises plural wheels provided at the end of legs 14 and 16. FIGS. 2A to 2D show an example of a wheel for use in a pushchair such as that shown in FIG. 1. It will be appreciated of course that the wheels can be provided on any pushchair or indeed on any small vehicle such as a wheel chair, a golf cart, a shopping trolley, or other such systems.

Referring to FIGS. 2A to 2C, the wheel comprises an inner hub 32 and an outer rim 34. A plurality of spokes 36 are provided coupled between the inner hub 32 and the outer rim 34. In the examples shown, the spokes are all substantially identical, but in another example, different configurations of spoke can be provided in the same wheel. Provided between each adjacent pair of spokes 36 there is formed an opening 38, the function of which will be described in greater detail below. In the example of FIGS. 2A to 2C, the opening is substantially triangular in shape, albeit that the sides are not necessarily straight lines.

The spokes are preferably arranged generally radially but not perpendicular to the inner hub 32. In the example shown the spokes, in their rest configuration are at an acute angle θ to a tangent to the hub. The spokes are also at an acute angle to a tangent to the outer rim. In the example shown the angle is the same but in other examples it need not be the same.

The wheel is provided as a unitary molded component in a preferred embodiment. In other examples, the wheel may be formed of a number of molded parts that are assembled together to form the entirety of the wheel structure. For example although preferred as a unitary moulded component in another examples the spokes could be provided as separate components assembled with a hub and rim to form the wheel. In this case the spokes could be provided as springs, helical, leaf, etc, connected to the hub or rim. The spokes could be provided as integral with one of the hub or rim and not integral with the other of the hub and rim. In this example, the spokes could be formed of a material different from the hub and/or rim.

The wheel is preferably formed of a plastic material which might typically have other materials integrated within it. For example, in one example the wheel is formed of a plastic with glass fibre integrated within the plastic so as to provide additional strength to the wheel. Importantly, by varying the constituent components of the molded material, the strength and flexibility of different parts of the wheel can be determined. In another example the wheel is formed of a rubber material optionally having other materials integrated within it. The skilled person will understand how to achieve such effect.

In use, the rigidity of the spokes is selected such that the wheel effectively is provided with an internal suspension mechanism. This ensures that a rider in the pushchair/pushchair or indeed any other small vehicle upon which the wheel is placed, does not experience any discomfort due to any irregularities or lack of smoothness of ground or surface on which the vehicle is positioned.

Referring to FIG. 2D, an enlarged section of the wheel can be seen. As noted above, between each adjacent pair of spokes, an opening 38 is provided. At the radially inner portion of each of the spoke 40 the width A of the spoke is substantially greater than the width B at the radially outer region 42. The effect of this variation in thickness of the spoke with radial displacement, is such as to bias the spoke and ensure that upon application of force to the rim, i.e. as a consequence of the wheel hitting an object or moving over an irregularity in a surface beneath, it does not deform uniformly, but rather the point along the radial length of the which bends significantly, can be determined or controlled.

In the examples shown, upon an initial application of force at a relatively lower level, the radially outer region of the spoke will deform elastically and move to the right in the example shown in FIG. 2D. As this occurs, due to the positioning and existence of the outer rim 34, adjacent spokes 36 will similarly be deformed. There will be something of a chain reaction and number of spokes will similarly deform at gradually decreasing amounts.

After a certain amount of deformation of one or more spokes, adjacent spokes will come into contact with each other in the radially outer region and, absent application of any additional compressive force, there will be no more deformation of the spokes.

In normal use of the wheel, when for example arranged on a pushchair, this will be the extent of the deformation of spokes on impact. However, when the outer regions of the spokes at a particular part of the wheel are in contact due to the deformation described above, if a further and greater amount of force is applied to the wheel, the lower, thicker, part of the spoke which is radially closer to the centre of the wheel, will be forced to deform until it engages with an adjacent spoke.

Thus, by this shaping and configuration of the spokes, i.e., by providing a spoke of varying thickness in which the thickness varies radially from a position at a radially inwards configuration where the thickness is relatively high, to a radially outer position where the thickness is low, a two stage compression process is enabled. This means that the wheel effectively has two modes of operation or rather two modes of suspension that are able to be provided when in use.

FIGS. 4A and B show exemplary embodiments of spokes for use in the wheel of any of FIGS. 1 to 3. In FIG. 4A the spoke has a continuous circular cross-section along its length but the material composition varies so as to produce a region or point 35 of greater flexibility at a desired position. Preferably, the region or point 35 of greater flexibility between 30 and 70% along the direction outwards towards the rim from the join at the hub

In the example of FIG. 4B, the spoke is shaped so as to have a cross-section that although consistent in shape gets smaller towards the centre again so as to produce a region or point 35 of greater flexibility at a desired position. It is as this position 35 where the knee forms upon compression in the first stage of response (of the two stages) of the flexible spoke.

In other examples, the spoke is shaped so as to have a varying shaped cross-section along its length. In other words, the shape (circular, elliptical, triangular, rectangular, running-track etc) of the cross-section is not consistent along the length of the spoke. In the non-limiting example shown, the region close to the hub has a cross-section that is substantially running-track shaped or rectangular. A gradual changing of the cross-section is provided such that a defined point, between 30 and 70% along the direction outwards towards the rim from the join at the hub, the cross-section is circular before transitioning back to a different shape such as substantially running-track shaped or rectangular.

The point at which the cross-section of the spoke is circular in this example, is preferably slightly smaller in cross-section (the numerical value of the cross-sectional area is smaller at the circular point than either side of the circular point) such that the knee is biased to form at this position in use.

FIGS. 5A and 5B are schematic views of a further example of a wheel for a pushchair. In this example the cross-section of each of the spokes is elliptical. Again, as the radial distance increases, the dimensions of the elliptical cross-section decrease such that the spoke is generally thinner further out towards the rim of the wheel. The elliptical cross section provides a significant advantage in that the external surface at any point on the spoke is smooth and curved. This reduces the chance that dirt or debris, that the wheel will inevitably encounter when on a pushchair being used outside, gets stuck in the wheel. The chance of dirt or debris such as stones or mud getting trapped between spokes is thus reduced. Accordingly, any possible deleterious effect on the function of the spokes is avoided or reduced by the provision of spokes with continuous smooth external surfaces.

In another example, the spokes are circular in cross-section which provides the corresponding benefit to the elliptically cross-sectioned spokes.

Referring to FIGS. 6A and 6B, an example of the wheel is shown in which a radial force F is provided on the wheel which might typically be due to engagement with an uneven projection on a surface on which it is rolling. The force F might typically be the reaction to the weight of the pushchair or indeed to some downwards force on the wheel at a point in time. FIG. 6A shows a rasterized version of the wheel indicating the relative stresses on components of the wheel. FIG. 6B shows clearly the relative deformation of individual spokes within the wheel.

It could be for example that the wheel is rolling roll over a stone on a pavement or might have dropped down into a crack or pothole in the pavement. In fact, in the example shown, it appears that the wheel is on a flat surface, but this is merely for the purpose of explanation. It will be understood that the force that is applied at that point to the wheel is radially inwards.

The spokes of the wheel have undergone the first stage of deformation referred to above. The radially outer regions of adjacent spoke pairs have come into contact. Looking at the lower most pair of spokes 44 and 46 in FIGS. 6A and 6B, a deformation has been produced such that spokes 44 and 46 have both deformed into a generally bent shape. In this example, a contact point or knee 48 has been established between the two spokes. The knee forms at a specific position along the length of spokes and the position is controlled by the variation in thickness of the spoke along its length, and/or the variation in composition of the material from which the spoke is made.

The effect of this that the first spoke 44 and second spoke 46 are brought closer together (compared to a pair of spokes at the upper uncompressed part of the wheel). See for example the relative separation of uppermost spoke pair 54 and 56 at this point of rotation. Nonetheless the first spoke 44 of the lowermost spoke pair arches away from the second spoke 46, maintaining distance between the spokes of the pair at the intermediate region of the spokes. A distance C is maintained between the spokes at the radially inner region of the spokes 46 and 44.

The material of the spokes 44 and 46 is of course in contact at the knee and the remaining part of the spokes that is not in contact is the thicker part that is radially more inward. This is still deformable due to the material from which it is made, but due to its increased thickness compared to the radially more outer part of the spokes, to deform further at this stage requires a greater degree of force. In other words, to bring the inner regions of the spokes together at this stage requires a greater force such that a second stage of a compression cycle is effectively provided by the configuration of the spokes. By selectively varying the width of the spokes such that it decreases in a radial direction the interaction of the spokes is controlled such that the radially outer regions deform first and only once a contact point between adjacent spokes has been defined, does the second radially inner region of the spoke have the potential to interact. The thicker nature of the radially inner region means that a greater force is needed to achieve deformation of the spokes at this stage.

It will be appreciated that the same two-stage compression effect can be achieved without requiring contact between adjacent spokes at the knee. In other words, it can be achieved simply in that when a first thinner part of the spokes has been deformed according to function, the second thicker part will not deform until the forces on it reach the required threshold level. Indeed, in some examples even without a knee forming in any of the spokes, it is possible that a two-stage compression or suspension effect can be achieved.

This can be further understood with reference to FIG. 6C. In this example a wheel under a light load is shown. The wheel 55 includes plural spokes, e.g. 57 and 59 on the upper half of the wheel 55. The wheel is under light load and in this condition there is no deformation of the spokes 57 and 59 in the top half of the wheel. However, the spokes, e.g. 61, 63 at the lower or bottom half of the wheel are deformed in an outer region. As can be seen the thickness of the spokes decreases as the radial distance increases, such that they get thinner along their length from the hub 32 to the rim 34. The consequence is that all the deformation of the spokes in the lower part of the wheel is outside of the region denoted by the dashed line (preferably a circle) 65. Inside the line 65, the spokes of the entire wheel are unaffected. A two stage compression is thus achieved without there necessarily being any contact between adjacent spokes.

This can be as a consequence of variation of the material composition, thickness or shape of the spoke along its length. For example, if each spoke is formed of a helical spring with a first section having one spring constant and a second having a different spring constant, upon application of pressure to the spoke, e.g. along its axial length, two stages of compression would be provided.

Another example includes each spoke being provided as a hydraulic mechanism or spring, e.g. including two or more telescopically mounted members arranged to slide relative to each other upon application of force. In both of the examples given above, the spokes would typically be provided in a simple radial arrangement connecting the hub to the outer rim or any intermediate rims if more than one annular region is provided.

Looking again at FIG. 2 (particularly FIG. 2C), it can be seen that in this example the thickness of the wheel is not uniform radially. In other words, at a radially greater distance, the thickness X of the wheel is smaller than it is at the radially inner region Y. This further provides a means by which the relative flexibility of the spokes along their lengths can be controlled. In particular, by providing the spoke with a lower thickness X at the radially outer portion than the thickness Y at the radially inner portion, the deformation of the spoke is biased to occur first in this radially outer region as opposed to the radially inner region where its axial length Y is greater (axial in the direction of the axis of rotation of the wheel). Alternative configurations are possible, e.g. in which X is the same as Y, or indeed in which X is greater than Y.

Preferably the material composition of the spokes does not vary along the length of the spoke such that the variation in flexibility derives only from the variation in width in the radial direction, and thickness (i.e. in the axial direction). However, in one example the material composition is further controlled to impart differing degrees of flexibility or rigidity to the spokes along their lengths.

Referring to FIG. 3, a second example of a wheel is shown. The general configuration is similar to that of FIGS. 2A to 2D, but in this case, the openings 50 between adjacent pairs of spokes 52 are generally trapezoidal or rectangular as opposed to being generally triangular in the example of FIGS. 2A to 2D. Again the spokes are configured such that in their rest or unstressed state each spoke forms an acute angle with the tangent to the hub.

FIG. 3D shows an enlarged part of the wheel shown in FIGS. 3A to 3C. As can be seen at the junction between a spoke and the outer rim 34, instead of providing a sharp angled connection, a smooth or radius connection is provided on both the circumferentially forward and circumferentially rearward connection points. As the connection 50 is curved or radius rather than linear and sharp. This is provided so as to reduce the risk of damage to the wheel over use.

As the wheel continually flexes and unflexes in use, eventually, some damage may occur to the connection between the spokes and rim 34. By providing a smooth or radiused connection point (as shown in FIG. 3D) between each of the spokes and the wheel rim 34 (and optionally or alternatively also the hub 32, the risk of damage or breakage is minimised.

The example shown in FIGS. 3A to 3D includes an increased number of spokes as compared to that of FIGS. 2A to 2D. This is preferable since it increases the portion of the outer surface of the wheel or rim 34 that is actually supported by material from one of the spokes. By contrast to the example shown in FIG. 2A to 2D, the reduced spoke thickness facilitates a greater number of spokes to be provided. Again, the general interaction of adjacent spokes is the same as that described above with reference to FIGS. 2A to 2D.

In use, it is expected that the wheels will be sized for arrangement on a small vehicle such as a pushchair or stroller. Particularly, back wheels and front wheels would be of the same size or alternatively the back wheel would be slightly larger than the front wheel. In one non-limiting example, the back wheel has a radius of between 18 and 24 cm and the front wheel has a radius of between 15 and 21 cm. Most preferably, the radius of the rear wheel is 21 cm and the radius of the front wheel is 18 cm. Preferably the ratio of radii for the rear and front wheels is 7:6. However, it will be appreciated that these values are given merely for purpose of example and are not limiting although they do represent a preferred embodiment.

The configuration of the wheel is such that in effect it is possible to think of the inner hub 32 being suspended by the spokes from the rim 34 in normal use. Thus, there will be a greater pressure on the spokes that at any point in time are lower. However, in use as the wheels rotates in normal use, the stress will be substantially equally distributed amongst all the spokes.

FIG. 7A is a schematic view of a further example of a wheel 58 for a pushchair. The wheel may be formed of similar materials and in similar ways to the wheel described above with reference to any of FIGS. 1 to 6. However, the wheel of this example includes two distinct and discreet radial or annular regions 63 and 65 of spokes.

The two regions include a radially outer region 63 and a radially inner region 65. They are separated by an intermediate rim 64 that is preferably generally cylindrical. The radially outer region 63 includes plural spokes 66 connecting the wheel's outer rim 60 and the cylindrical intermediate rim 64. The radially inner region 65 includes plural spokes 68 connecting the wheel's hub 62 and the cylindrical intermediate rim 64.

It can be seen that the spokes 66 of the radially outer region 63 are thinner (and therefore will be more flexible presuming uniform material composition) than the spokes 68 of the radially inner region 65. The wheel operates in a manner similar to the manner of operation of the wheel of FIGS. 1 to 6. That is to say, the wheel has two modes of operation or rather two modes of suspension that are able to be provided when in use.

Upon a first level of compressive force the relatively thinner spokes 66 of the radially outer region will respond by deforming. After reaching an equilibrium position, the relatively thicker spokes 68 of the radially inner region 65 will respond by deforming if a greater force is applied.

In this example the knee described above is in effect replaced by the cylindrical intermediate rim 64. Again, it is possible that contact between adjacent spokes 66 of the radially outer region occurs before the spokes of the inner region 65 are activated or caused to deform at all. However, the bending of the inner spokes is simply between the hub 62 and the cylindrical intermediate rim as opposed to being between a contact point or knee and the hub as in the examples shown in, say, FIGS. 1 to 6 and described above.

In one example two or more intermediate rims are provided thus dividing the region between the outer rim and the inner hub into more than 2 regions for spokes. For example, there could be provided two intermediate rims, respectively separating regions within the wheel for spokes of different thicknesses or material compositions as described above.

FIG. 7B shows, schematically, such an arrangement. In this example 2 intermediate rings 64₁ and 64₂ are provided. The first of the intermediate rings 64₁ is the outer limit of a first region 70 defined between the hub 62 and the first of the intermediate rings 64₁. The second of the intermediate rings 64₂ is the outer limit of a second region 72 defined between the first and second intermediate rings 64₁ and 64₂. The third region 72 is defined between the second of the intermediate rings 64₂ and the outer rim 60.

As shown, also schematically within each of the regions 70, 72 and 74, spokes 76, 78 and 80 are provided. Only a single spoke is shown in the figure but of course they will be provided all the way round as in FIG. 7A, the spokes in each of the regions are the same within the region, but different from the spokes in another region. Thus, spokes 76 within region 70 are all the same, spokes 78 within region 72 are all the same and spokes 80 within region 74 are all the same. However, spokes 80 within region 74 are more flexible than spokes 78 and 76 within regions 72 and 70, respectively, and spokes 78 within region 72 are more flexible than spokes 76 within region 70.

Thus, a progressive compression of the spokes will occur upon application of force to the wheel so that, like the examples described above a multi-stage suspension effect is provided. In the example of FIG. 7B a three-stage suspension effect will be provided. If desired, further regions can be provided such that a suspension effect of any number of desired stages can be achieved.

It can be seen then that what is provided is a wheel in which a number (two or more) of annular regions are provided each with a plurality of spokes. Preferably, the spokes in each of the annular regions have different flexibilities from those of the other annular region(s). For example, the plurality of spokes of the wheel overall may include a radially inner plurality of spokes in a first annular region, a radially intermediate plurality of spokes in a second annular region and a radially outer plurality of spokes in a radially outer region. An intermediate rim is provided between each of the adjacent annular regions.

Looking at FIG. 7A it can be understood that an advantage of this arrangement is that when the outer spokes 66 have reached their maximum compression, the cylindrical intermediate rim 64 serves to distribute the load more evenly onto the less flexible spokes 68 of the radially inner region 65. Furthermore, the cylindrical intermediate rim 64 also provides increased lateral stability to the wheel. Corresponding points apply to the arrangement of FIG. 7B in which 3 annular regions are provided.

The shape of the individual spokes (e.g. the cross section of each spoke) could be the same as that described above with reference to any of FIGS. 1 to 6. It is likely that the spokes will all have the same cross section, but in one example the cross section of spokes of one of the annular regions, say, the inner region 65 in FIG. 7A, is different from that of the spokes of the outer region 63, in FIG. 7A.

Embodiments of the present invention have been described with particular reference to the examples illustrated. However, it will be appreciated that variations and modifications may be made to the examples described within the scope of the present invention.

1. A wheel for a small vehicle, the wheel comprising a an inner hub for connection to an axle an outer rim for engaging the ground in use a plurality of spokes connected between the inner hub and the outer rim, wherein the spokes are flexible.

2. A wheel according to claim 1, in which the spokes have a thickness or cross-sectional area that varies along its length.

3. A wheel according to claim 2, in which the spokes have a thickness or cross-sectional area that decreases from a radially inner position to a radially outer position.

4. A wheel according to claim 1, in which the spokes have a thickness or cross-sectional area that decreases continually from a radially inner position at its connection to the inner hub to a radial outer position at its connection with the outer rim, or vice versa.

5. A wheel according to claim 1, in which the spokes have a variation in thickness, shape or material along their length such that in use they provide a two stage suspension effect.

6. A wheel according to claim 5, in which under a first load any deformation of the spokes is in a radially outer region between the rim and an annular shape between the rim and the hub.

7. A wheel according to claim 6, in which annular shape is a circle.

8. A wheel according to claim 5, in which the variation in thickness or cross-sectional area is provided such that upon application of a first force one or more of the spokes deforms defining a knee.

9. A wheel according to claim 8, in which the defined knee comes into contact with an adjacent spoke.

10. A wheel according to claim 9, in which the variation in thickness, shape, material or cross-sectional area is provided such that when the defined knee has come into contact with an adjacent spoke, the remainder of the spoke will come into contact if the force exceeds a defined threshold, higher than the force required to bring the knees into contact.

11. A wheel according to claim 1, in which each spoke connects to the inner hub at one circumferential position and to the outer rim at a different circumferential position such that the spoke is sloped between the inner hub and the outer rim defining an acute angle between a tangent to the hub or the rim.

12. A wheel according to claim 1, in which the connection between at least one of the spokes and the outer rim is radiused.

13. A wheel according to claim 1, in which the connection between at least one of the spokes and the inner hub radiused.

14. A wheel according to claim 1, in which the wheel is a moulded wheel.

15. A wheel according to claim 14, in which the wheel is a unitary moulded wheel.

16. A wheel according to claim 1, in which the wheel is formed of a uniform composition throughout.

17. A wheel according to claim 1, in which the wheel is formed of a composition that varies along the length of the spokes.

18. A wheel according to claim 1, in which the diameter of the wheel is between 3 and 50 cm, and preferably between 10 and 40 cm and most preferably between 18 and 28 cm.

19. A wheel according to claim 1, in which the plurality of spokes includes a first annular region of spokes being a radially inner plurality of spokes and a second annular region of spokes being a radially outer plurality of spokes and an intermediate rim provided between the first and second annular regions of spokes.

20. A wheel according to claim 19, comprising one or more additional annular regions of spokes, radially offset from the inner plurality of spokes the radially outer plurality of spokes and a corresponding additional intermediate rim.

21-25. (canceled)
